(19) United States
(12) Patent Application Publication
(10) Pub. No.: US 2026/0260034 A1
(43) Pub. Date: Sep. 3, 2026

(54) METHOD FOR PREDICTING THE REMAINING USEFUL LIFE OF A SEAL ARRANGEMENT OF A PISTON COMPRESSOR

(71) Applicant: BURCKHARDT COMPRESSION AG, Winterthur (CH)

(72) Inventor: Alina BEY, Winterthur (CH)

(73) Assignee: BURCKHARDT COMPRESSION AG, Winterthur (CH)

(21) Appl. No.: 18/875,429

(22) PCT Filed: Jun. 8, 2023
(86) PCT No.: PCT/EP2023/065418

§ 371 Date: Dec. 16, 2024

(30) Foreign Application Priority Data
Jun. 14, 2022 (EP) 22179017.3

(51) Int. Cl. G06F 30/20; F04B 49/10; G06F 119/02

(52) U.S. Cl. CPC G06F 30/20; F04B 49/10; G06F 2119/02

(57) ABSTRACT

A computer-implemented method for predicting remaining service life of a sealing arrangement of a reciprocating compressor includes: generating an input matrix from vibration data of a reciprocating part of the compressor; performing simulation steps by applying an error propagation model on the input matrix, each simulation step results in an output matrix, and the output matrix of the n^{th} simulation step is used as the input matrix of the n+1^{th} simulation step; selecting one parameter from the values of the output matrices; determining the number of simulation steps performed until the selected parameter falls below a threshold value, and outputting this number in a time unit as the result of the simulation performed; and fitting a curve to the simulation results and calculating the time at which the curve intersects a lower boundary, the calculated intersection point being an indicator for the predicted end of the service life.

The present invention relates to a method for determining the degree of degradation as well as for predicting the remaining service life of a sealing arrangement of a reciprocating compressor, a preventive maintenance system for a reciprocating compressor, a reciprocating compressor comprising a preventive maintenance system, a computer-readable storage medium, and the use of the method for monitoring the degradation of a sealing arrangement of a reciprocating compressor and/or for predicting the remaining service life of a sealing arrangement of a reciprocating compressor and/or for adjusting the leakage occurring at a sealing arrangement of a reciprocating compressor.

Condition monitoring is the process of monitoring a condition parameter (vibration, temperature, etc.) in machins to identify a significant change that indicates a developing fault. It is a key component of predictive maintenance, which is also known as “preventive maintenance” and “predictive maintenance”. Preventive maintenance allows maintenance work to be planned or other measures to be taken in order to avoid unexpected machine downtime or consequential damage and its consequences. This can improve the availability of production systems and at the same time reduce system downtimes and maintenance costs.

For the compression of fluids such as gases or aerosols, compressors are usually used. In a reciprocating compressor, the rotary motion of a crankshaft generated by a drive unit is converted into a reciprocating motion of one or more pistons by means of connecting rods, which is used to compress gas or aerosol sucked into a compressor unit. By design, the piston is subjected to the forces that occur in the process, which accelerate the piston from a speed of zero at the end of each stroke to a high speed in the middle of the stroke and back to zero again. For at least part of the compression cycle, the compression chamber is sealed by closed cylinder valves before the compressed gas or aerosol is released to an output device by opening at least one cylinder valve. Due to their movements, these valves are subject to a certain amount of wear. Piston rod sealing systems, so-called packings, are used on the moving piston rod to seal the crank-side working chamber. Due to the contact of the sealing elements with the oscillating piston rod, they are subject to constant wear.

The unwanted escape of the gas or aerosol to be compressed from the compressor unit, in particular due to the wear-related leakage of the sealing elements and/or cylinder valves described above, is commonly referred to as leakage. To measure the leakage—and thus to assess the functionality of the compressor unit—corresponding sensors can be used, which are ideally arranged on each individual compressor unit or stage of the compressor. However, such sensors are often not provided on the compressor for cost reasons and/or do not always automatically record and transmit the leakage values they measure.

A method for monitoring the operation of a reciprocating compressor with a pressure sensor and a vibration sensor is known from EP 2 458 214 A1. Based on the detected pressure within the device and the detected vibrations of the reciprocating device of the compressor, the protection system described therein calculates a stiffness value of the cylinder assembly and thus enables the structural integrity of the same to be assessed during operation. The protection system also enables the compressor to be shut down after it has been determined that the condition of the compressor deviates from a predefined standard condition.

EP 3 436 877 A1 relates to a method and a device for carrying out a method for vibration-diagnostic monitoring and evaluation of individual machine parts. At least one time signal of the vibration of the machine is recorded and evaluated by means of a frequency analysis by a frequency analyzer. Specific machine parts are then assigned frequency maxima extracted from the frequency spectrum, which are compared with target value data, model data and/or reference data of the respective machine parts. If the extracted frequency maxima, which are determined from the currently measured vibration data, deviate from the target value data, the model data and/or the reference data of the machine parts, an assessment information or warning message is output.

However, the disadvantage of the aforementioned methods and systems is the fact that the user is only notified if one of the calculated values deviates from the ideal value. Real-time transmission of the remaining service life and an indication of the degree of wear of the compressor's sealing elements are not possible with these methods and systems. Consequently, there is still a need for methods and systems that can also make accurate predictions about the future condition and time of failure of machine parts such as sealing elements. Furthermore, during preventive maintenance it is often the case that parts with a long remaining service life are replaced. Such premature replacement causes unnecessary costs and is not very sustainable.

Also known from the state of the art is the article “Abrupt fault remaining useful life estimation using measurement from a reciprocating compressor valve failure” by Loukopoulos et al. (Mechanical Systems and Signal Processing 2019, 121, 359-372), which deals with the comparison of the prognostic performance of different methods for estimating the remaining service life (RUL) of reciprocating compressors in terms of the accuracy and precision of the compared methods. The forecasting methods discussed are data-driven methods in which the degradation process is modeled using historical information. The data used for the calculation originates from an industrial reciprocating compressor and was retrieved from a server. Those are therefore not live raw data from sensors attached to or measuring the compressor.

The disadvantage of such methods, however, is that they reach their limits with new error events, i.e. cases for which they have not been trained, and that the accuracy of the forecast generally depends on the quantity and quality of the available data.

Based on the aforementioned prior art, the present invention is based on the problem of eliminating such and other disadvantages of the prior art and, in particular, providing a method with which the degree of wear of a sealing arrangement of a reciprocating compressor can be determined and its remaining service life can be predicted cost-effectively and reliably.

The problem is solved by a method, a preventive maintenance system for a reciprocating compressor, a reciprocating compressor, a computer-readable storage medium, and the use of the method for monitoring the degradation of a sealing arrangement of a reciprocating compressor and/or for predicting the remaining service life of a sealing arrangement of a reciprocating compressor and/or for readjusting the leakage occurring at a sealing arrangement of a reciprocating compressor in accordance with the independent patent claims. Advantageous embodiments and further developments are the subject of the dependent claims. The problem is solved in particular with a computer-implemented method for determining the degree of wear and for predicting the remaining service life of a sealing arrangement of a reciprocating compressor. The method comprises the following steps a) to h):
a) Provision of vibration data of the reciprocating part of the reciprocating compressor. Alternatively, it is also conceivable that features that can be calculated from vibration data are used in the method according to the invention. The vibration data or features that can be calculated from it must be traceable to specific positions (segments M) of the movement of the reciprocating part of the reciprocating compressor.
b) Creating an input matrix from the vibration data or the features that can be calculated from it. The input matrix has a dimension (M×N) determined by the number of segments M and the number of sampling times N.
c) Performing a simulation comprising a plurality of simulation steps applying a model, that can be used to describe the propagation of errors in a closed system, on the input matrix. Each simulation step generates an output matrix. The output matrix of the n^{th} simulation step is used as the input matrix of the n+1^{th} simulation step.
d) Optionally, form the Laplacian matrix for each output matrix and calculate the eigenvalues of the respective Laplacian matrix. The Laplacian matrix can be obtained in particular by multiplying the respective output matrix with its transposed matrix.
e) Optionally, calculation of the normalized distance of the output matrix to the output matrix of the previous simulation step.
f) Selection of exactly one parameter, either from values of the output matrices, from the calculated eigenvalues of the Laplacian matrices formed in optional step d) or from the normalized distances calculated in optional step e). The selected parameter represents a measure for the synchronization of the vibration data traceable to the segments M or features that can be calculated from them.
g) Determination of the number of simulation steps that must be carried out until the selected parameter falls below a predefined threshold value close to zero. This result of the simulation performed, i.e. the determined number of simulation steps, is converted into a time unit based on the sampling rate of the vibration data used in the input matrix or the features that can be calculated from it.
h) Repetition of the method steps a) to g) described above at regular discrete intervals to obtain a large number of simulation results.
i) After each new simulation, a curve is adapted to the simulation results obtained, in particular by means of local linear regression or another suitable method, taking into account the past simulation results, and the point in time in the future at which the curve intersects a predefined lower boundary is determined. The lower boundary is in particular the abscissa axis (x-axis) running through the zero point of a Cartesian coordinate system. The calculated point in time at which the curve adapted to the simulation results intersects the lower boundary is regarded as an indicator for the occurrence of a malfunction, in particular for a total failure, and the predicted end of the service life of the sealing arrangement.

In the context of the present invention, the term “sampling time” is understood to mean the time at which a value, in particular a vibration data value or the value of a feature that can be calculated therefrom, is measured or calculated.

In the context of the present invention, the term “sealing arrangement” means in particular a piston rod packing that seals a piston rod and/or a cylinder valve that seals a compression chamber.

The size of the predefined threshold value depends on the input data, i.e. the vibration data or the features that can be calculated from it, and is close to zero, since the approximation of the second smallest eigenvalues to zero suggests a high system instability.

The present invention is based on the realization that leaks have an effect on the vibrations measured on the compressor. In particular, in addition to increased leakage, broken packing or guide rings also lead to a displacement or deviation of the piston rod and the piston from their ideal movement, increased friction and vibrations in the respective segments of the piston movement. As the acceleration forces of the piston are greatest in the middle of the piston movement, the displacement is also greater in this area and is noticeable through increased vibrations. When increased leakage occurs, this displacement increases further and is accompanied by increased vibrations that spread across several neighboring segments of the piston movement towards the end of the stroke.

This is reflected in the simulation phase of the present invention, in which the speed of propagation of a fault in the direction of the stroke end is simulated. The mapping of the measured vibrations to segments of the motion of the reciprocating part of the reciprocating compressor, in particular to a particular position of the piston, is a necessary pre-processing step to ensure that the input matrix is a two-dimensional representation of the vibrations measured over a full cycle of the reciprocating device. Without wishing to be limited to this, it is assumed that the vibration pattern over the movement of the reciprocating device, in particular over the piston movement, represents the thermodynamic processes inside the cylinder. This hypothesis is supported by information from experts in manual machine diagnostics who report the association of possible leakage or increased friction in segments with a uniform and parallel increase in vibration peaks in these segments.

In the context of the present invention, the vibrations occurring in the respective segments of the piston movement and their propagation to neighboring segments are considered as interacting particles. Due to the temporal development of the vibrations, the time-dependent Ginzburg-Landau model (TDGL), for example, can be used to describe the dynamics between the particles, which is a modification of the kinetic Ising model in which discrete variables represent the states of the magnetic spins (−1, +1) of the particles. The free energy of such a system is estimated by observing the change in the order parameter (G. Gaspari, Physical Review B 1986, 33(5), 3295-3305).

The method according to the invention is basically a hybrid digital sensor that uses vibration data to simulate the function or measurement of a leakage sensor. In other words, the method according to the invention makes it possible to simulate the leakage that is not measured directly using another parameter, namely vibration data or features that can be calculated from it, and to predict packing or valve damage. The selected method does not require additional pressure or temperature sensors or the calculation of dynamic pressures and is therefore cost-effective in terms of the necessary sensor technology. Furthermore, the method according to the invention has proven to be particularly robust with regard to the accuracy of the predicted end of the service life of the sealing arrangement, for example with regard to a changing utilization of the compressor or other fluctuations that are not due to wear.

In a preferred embodiment of the method according to the invention, the second smallest eigenvalue of the output matrix is selected as the parameter. In this case, the predefined threshold value is approximately zero, for example an amount of 0.000025.

In a preferred embodiment of the method according to the invention, method step d) is carried out and the second smallest eigenvalue of the Laplace matrix is selected as the parameter. In this case, the predefined threshold value is approximately zero, for example an amount of 0.000025.

The second smallest eigenvalues of the Laplace matrix are called algebraic connectivity or Fiedler eigenvector (M. Fiedler, Czechoslovak Mathematical Journal 1973, 23(2), 298-305). This metric plays a crucial role in the synchronization of coupled oscillators and the robustness of networks, cascading failures, etc. (S. Strogatz, Physica D 2000, 143, 1-20). If the algebraic connectivity of a graph reaches zero, the graph is split into more than one connected component, i.e. a dynamic process will never synchronize (Hernández et al., Journal of Complex Networks 2014, 2(3), 272-287).

On the one hand, the method according to the invention can be carried out remotely, whereby the vibration data measured on the compressor is sent to an independent location and evaluated there.

Alternatively, in a further embodiment of the method according to the invention, it is also conceivable that the vibration data provided or the features that can be calculated therefrom are obtained as part of the method carried out. For this purpose, at least one time signal x(t) of the vibration of a reciprocating part of the reciprocating compressor is detected by at least one vibration sensor. Optionally, the features can be calculated from the recorded time signal x(t). The detected time signal x(t) of the vibration or the optionally calculated features is then divided into a plurality of time segments, which always correspond to the same position of the reciprocating device, in particular the piston or the piston rod. For each time segment, the mean value of the time signal x(t) recorded in the respective time segment or the features optionally calculated from it is then calculated in order to obtain averaged vibration values or averaged features. Furthermore, the position of the reciprocating part of the reciprocating compressor is detected by at least one position sensor and the detected position data is provided for carrying out the method. Based on the recorded position data, the movement of the reciprocating part is subdivided into a plurality of segments M, which are preferably of equal size. Finally, the averaged vibration values or the averaged features are assigned to the segments M of the movement in such a way that the respective averaged vibration values or the respective averaged features always correspond to the same segments M of the movement of the reciprocating part and thus a leak at a certain point is reflected accordingly in the vibration data. For example, the time interval is one minute, i.e. within one minute a certain number of measurement points are obtained in a certain segment M of the movement of the reciprocating part, which measurement points are averaged and provided as a minute average value of the respective segment M for the input matrix.

In a preferred embodiment of the method according to the invention, the time at which the selected parameter falls below the predefined threshold value is only predicted after the parameter reaches a predetermined criticality value. The criticality value marks the onset of an irreversible deterioration process in the sealing arrangement.

This significantly reduces the fluctuation range of the simulation results and thus increases the accuracy of the predicted time at which a malfunction of the sealing arrangement actually occurs. Furthermore, the start of the predictions is shifted in the direction of the actual failure, which increases the accuracy of the predictions and reduces the risk of false positive prediction results.

In a preferred embodiment of the method according to the invention, the model applied to the input matrix is the time-dependent Ginzburg-Landau model (TDGL).

In the context of the present invention, it was found that the time-dependent Ginzburg-Landau model (TGDL) as a generalization of the n-vector and the 2D Ising model (Gaspari et al., Physical Review B 1986, 33(5), 3295-3305) fits the present experimental context particularly well.

The use of reciprocating compressors often takes place under conditions that have an external influence on the vibrations of the reciprocating part of the reciprocating compressor. For example, when using reciprocating compressors on seagoing vessels, the prevailing wave pattern and the associated ship movements themselves can cause vibrations that can overlap with the vibrations detected on the reciprocating compressor.

To reduce such effects, the provided vibration data or the provided features can be additionally denoised.

In a preferred embodiment of the method according to the invention, the provided and optionally denoised vibration data or features are normalized between −1 and +1, which is advantageous depending on the selected model and distribution of the vibration data.

In a preferred embodiment, the method according to the invention further comprises a data transmission step for transmitting the vibration data or features to at least one ground station. Additionally or alternatively, it is also conceivable that the method according to the invention comprises a data transmission step for transmitting the predicted remaining service life of the sealing arrangement to a user interface of the reciprocating compressor. In both cases, at least the simulation steps and the prediction of the time at which the selected parameter falls below a predefined threshold value are carried out in whole or in part on the ground with the ground station.

The transmission of the vibration data measured on the reciprocating compressor to a ground station makes it possible to monitor the condition of the reciprocating compressor remotely without the need for all the computing power required to carry out the method according to the invention to be available on or in close proximity to the reciprocating compressor. Furthermore, the transmission of the predicted remaining service life of the sealing arrangement to a user interface of the reciprocating compressor, for example to a control panel or a signal light of the reciprocating compressor, makes it possible for the users of the reciprocating compressor not to be surprised by a supposedly unforeseeable failure of the reciprocating compressor. This can be particularly advantageous when monitoring reciprocating compressors used on seagoing vessels, as an unforeseen failure of the reciprocating compressor outside of ports can pose a considerable safety risk.

In a preferred embodiment, the method according to the invention further comprises transmitting the identified time and/or the predicted end of the service life of the sealing arrangement to a user. This transmission is preferably in real time. In addition or alternatively, according to the invention, it is also conceivable to estimate the degree of wear of the sealing arrangement from the behavior of the parameter over the number of simulation steps performed and to transmit the degree of wear thus obtained to a user. This transmission also preferably takes place in real time.

This enables the user of the reciprocating compressor to be informed of its condition and, if necessary, to take timely precautions for any necessary maintenance interruption.

In a preferred embodiment of the method according to the invention, the sealing arrangement is a piston rod packing that seals against a piston rod or a cylinder valve that delimits a compression chamber. Piston rod packings and cylinder valves are among the parts of a piston compressor whose damage or even failure lead to a serious impairment of the compression process and thus reduce the performance of the piston compressor. In a preferred embodiment of the method according to the invention, the execution of the method is started automatically, namely at a time that can be selected by a user or at fixed time intervals.

This automation of the process significantly reduces the risk of unforeseen failure of the reciprocating compressor. On the other hand, it also allows the performance of maintenance work prescribed by the manufacturer and/or user to be monitored.

In principle, all of the above-mentioned embodiments can be combined with each other.

The problem is further solved by a preventive maintenance system for use with a reciprocating compressor. The preventive maintenance system comprises a calculation device with at least one processor. The calculation device is configured to receive position data of a reciprocating part of the reciprocating compressor, to receive vibration data or features of the reciprocating part of the reciprocating compressor that can be calculated therefrom, and to assign these vibration data or features to segments M of the movement of the reciprocating part of the reciprocating compressor. The calculation device is further configured to create an input matrix from the received vibration data or features and to perform a plurality of simulations, each comprising a plurality of simulation steps, on the input matrix using a model which can be used to describe the propagation of errors in a closed system. This results in each case in an output matrix, whereby the output matrix of the n^{th} simulation step is used as the input matrix of the n+1^{th} simulation step. The interval between two simulations corresponds to a defined time unit in each case. In particular, the interval between two simulations can be between one minute and six hours, preferably between one minute and four hours, particularly preferably between one minute and sixty minutes. The smaller the time interval between two simulations is selected, the smoother the results will be, although the time required to obtain the results will increase. The calculation device is optionally further configured to form the Laplace matrix of the respective output matrix and to calculate the eigenvalues of the respective Laplace matrix or to calculate the normalized distance of the output matrix of the n+1^{th} simulation step to the output matrix of the n^{th} simulation step. The calculation device is also configured to select a parameter from the values of the output matrices or from the calculated eigenvalues of the optionally formed Laplacian matrices or from the optionally calculated normalized distances. The selected parameter represents a measure for the synchronization of the vibration data that can be traced back to the segments M or features that can be calculated from them. The calculation device is configured to determine the number of simulation steps that must be carried out until the selected parameter falls below a predefined threshold value close to zero as a result of the simulation carried out in each case and to output this number in a time unit. The time unit or simulation time is calculated from the time interval of the (averaged) values entering the input matrix, which are generated from the vibration data. The calculation device is also configured to adapt a curve to the simulation results obtained and to use a suitable method (local linear regression, for example) to calculate the time in the future at which the curve intersects a predefined lower boundary, in particular the x-axis, and thus to obtain the failure time as a date. The calculated intersection point is regarded as an indicator for the occurrence of a malfunction and the predicted end of the service life of the sealing arrangement. Ultimately, the calculation device is also configured to output the remaining service life of the piston compressor seal arrangement based thereon.

The advantages of the preventive maintenance system according to the invention essentially result from the advantages already described for the method according to the invention.

In an advantageous embodiment, the preventive maintenance system according to the invention further comprises at least one position sensor, which is designed to detect the position of the reciprocating part of the reciprocating compressor and is communicatively coupled to the calculation device. In this embodiment, the preventive maintenance system further comprises at least one vibration sensor, which is designed to detect a time signal x(t) of the vibration of a reciprocating part of the reciprocating compressor and is communicatively coupled to the calculation device. The calculation device is configured to divide the detected time signal x(t) of the vibration into a plurality of time segments and to form the averaged vibration values of the respective time segments. In addition, the calculation device is configured to divide the movement of the reciprocating part into a plurality of segments M, preferably of equal size, on the basis of the determined position, and to assign the averaged vibration values to these segments M of the movement.

This allows the condition of the piston compressor's sealing arrangement to be monitored even more closely and the remaining service life to be predicted more accurately.

In a preferred embodiment of the preventive maintenance system according to the invention comprising at least one position sensor, at least one of the vibration sensors is arranged on the cylinder head or crosshead of the reciprocating compressor, which cylinder head or crosshead is associated with the reciprocating part of the reciprocating compressor.

It has been found that the arrangement of the vibration sensor on the cylinder head enables particularly reliable statements to be made regarding the condition and the remaining service life of the cylinder valves, in particular the exhaust valve. On the other hand, it has been found that the condition and the remaining service life of a piston rod packing can be obtained particularly accurately by positioning the vibration sensor on the crosshead.

The problem is further solved by a reciprocating compressor comprising a preventive maintenance system as described above.

In a preferred embodiment, the piston compressor is designed as a piston compressor with vertical piston movement. The vertical piston movement ensures low wear of the sealing and guide elements. Piston compressors of this type are often used on seagoing vessels.

The problem is further solved by a computer-readable storage medium. The computer-readable storage medium embodies a computer program comprising a computer-readable program code. The program code, when executed by at least one processor of a computer, is adapted to cause the processor to perform the method described herein.

In the context of the present invention, the term “storage medium” also includes, in particular, cloud storage, flash memory and embedded memory.

The problem is ultimately solved by using the method described herein for monitoring the degradation of a sealing arrangement of a reciprocating compressor. Alternatively or additionally, the problem is solved by using the method described herein for predicting the remaining service life, in particular predicting the remaining operating hours or the replacement date, of a sealing arrangement of a reciprocating compressor. As a further alternative or in addition to the above-mentioned uses, the problem is solved by using the method described herein to reproduce the leakage occurring at a sealing arrangement of a reciprocating compressor.

Various embodiments of the invention are explained in more detail below with reference to drawings, wherein identical or corresponding elements are generally provided with the same reference signs. It shows:

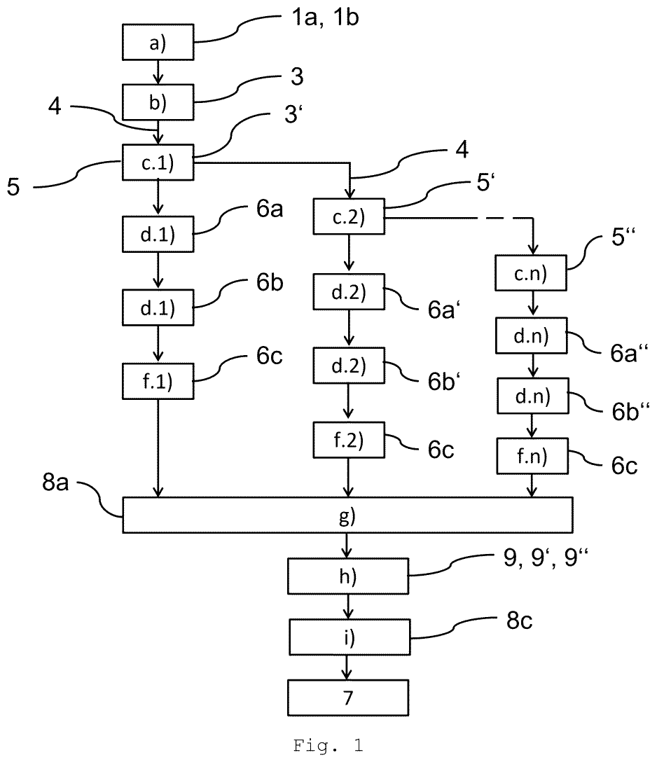

FIG. 1 Flow chart showing a process sequence according to the invention;

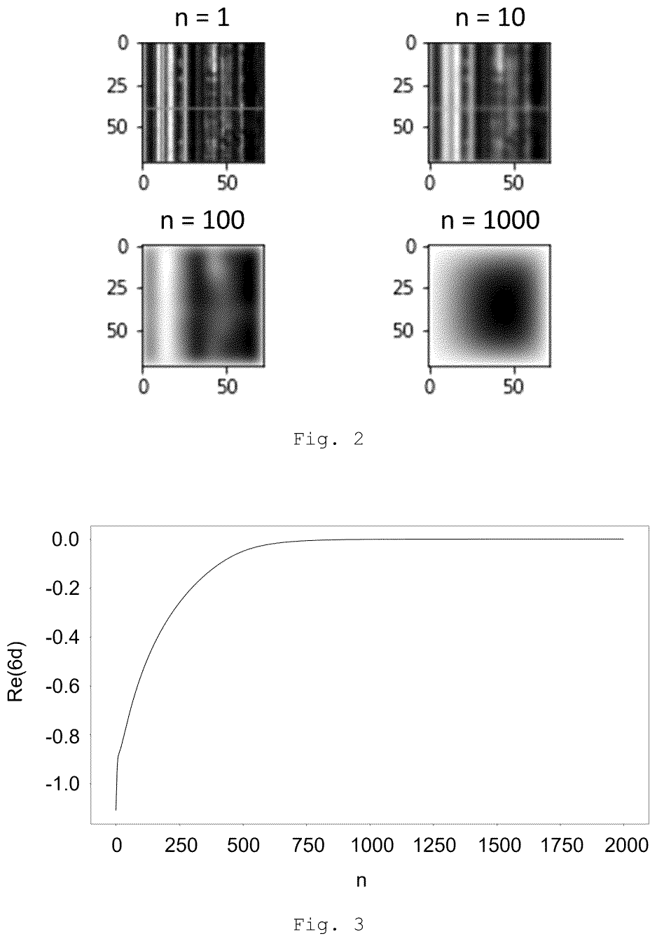

FIG. 2 Graphical representation of output matrices 5, 5′ after n simulation steps;

FIG. 3 Progression of the real parts Re of the second-smallest eigenvalues 6d over the n simulation steps of a simulation;

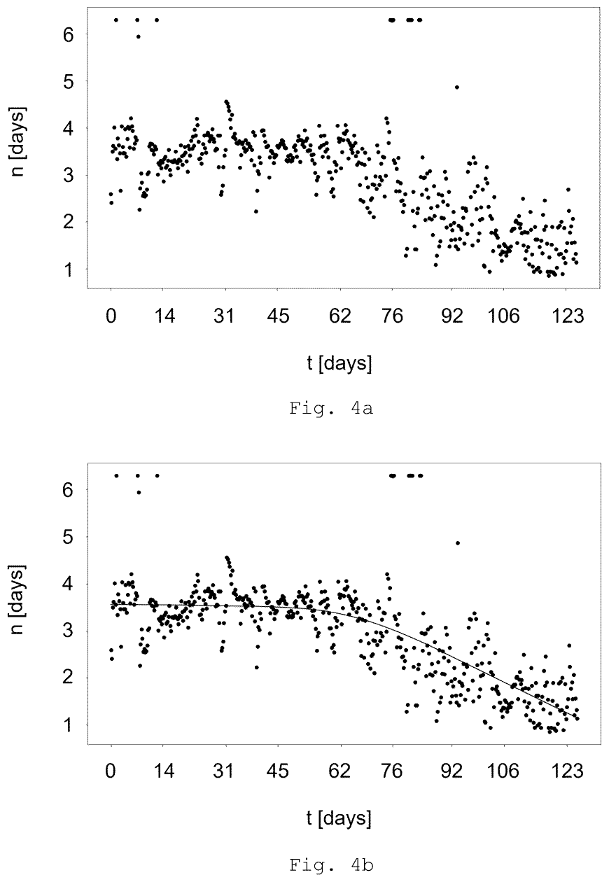

FIG. 4a Simulation results 9, 9′ for all simulations started;

FIG. 4b Local linear regression of the simulation results 9, 9′ from FIG. 4a;

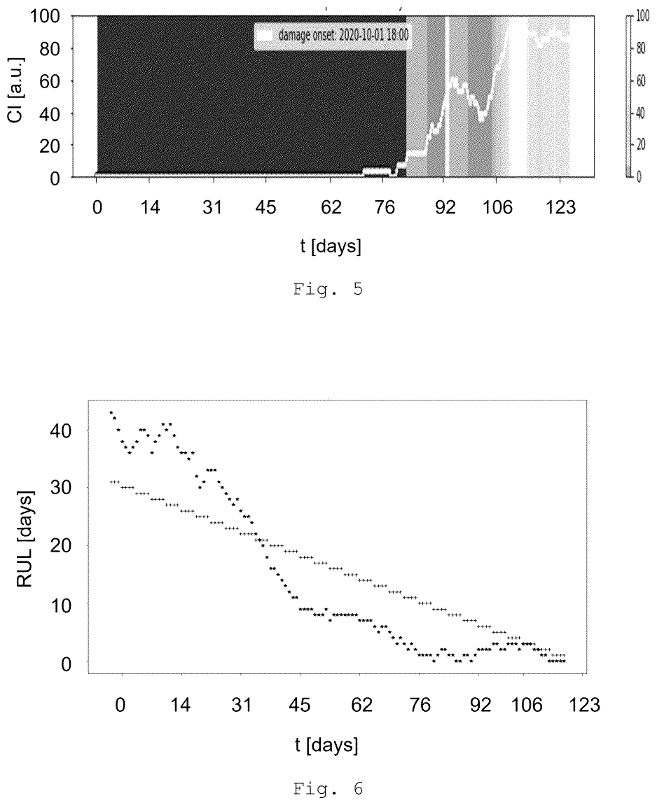

FIG. 5 Development of the criticality index CI over time;

FIG. 6 Actual and predicted remaining service life after using the irreversible degradation process from FIG. 5;

FIG. 1 shows a flow chart illustrating the sequence of a possible embodiment of the method according to the invention for determining the degree of wear and predicting the remaining service life of a sealing arrangement of a reciprocating compressor. Following the vibration data 1a provided in step a), which are considered by at least one of the vibration sensors belonging to the reciprocating compressor, or the features 1b calculated therefrom, an input matrix 3 is generated in step b). For example, this includes the generation of the data structure from the measured vibration data 1a or the features 1b calculated therefrom in such a way that a column in the input matrix 3 represents the vibration data 1a or the features 1b calculated therefrom at a specific position of the piston and the rows of the input matrix 3 represent the change in the vibration data 1a or the features 1b over time. This results in either an N×N matrix 3 or an N×M matrix 3. Different positions of the vibration sensor(s) on the reciprocating compressor allow conclusions to be drawn about the criticality of the degradation and the type of seal arrangement. Following step b), a simulation comprising a number of simulation steps is started in step c). In step c.1), the state field-based simulation of the vibration dynamics is carried out, in this example using the time-dependent Ginzburg-Landau model 4. Correctly applied, the results of the large number of existing state field models 4, which can be used to describe the propagation of faults in closed systems, are equivalent. To solve the partial differential equation, the discrete version of the Laplace operator Δ is recursively applied to the output matrix 5 of the previous simulation step in each simulation step. In the example shown in FIG. 1, the output matrix 5 of the first simulation step c.1) is therefore used as the input matrix 3′ of the second simulation step c.2), which in turn produces output matrix 5′. FIG. 2 shows the output matrices 5, 5′ after a different number of simulation steps in the form of a heat map. The figure belonging to time n=1 shows a plurality of white and black dots, which represent the values (states) of the output matrix 5 after the first simulation step. After a number of simulation steps, the output matrix changes only marginally. In the embodiment of the method according to the invention shown in FIG. 1, the Laplacian matrix 6a, 6a′, 6a″ is formed after each of the steps c.1) to c.n) for the output matrix 5, 5′, 5″ obtained. This can be done, for example, by multiplying the respective output matrix 5, 5′, 5″ with its transposed matrix (not shown). The eigenvalues 6b, 6b′, 6b″ of the respective Laplacian matrices 6a, 6a′, 6a″ of a simulation step are then calculated, which is explicitly shown in the flow chart in FIG. 1 for process steps d.1), d.2) and d.n). For each simulation step, exactly one parameter 6c is now selected from the calculated eigenvalues 6b, 6b′, 6b″, as illustrated by the process steps f.1), f.2) and f.n). In the example described here, the selected parameter 6c is the second smallest eigenvalue of each simulation step. FIG. 3 shows an example of the progression of the real parts Re of the second smallest eigenvalues 6d over the n simulation steps of a simulation. In method step g), the simulation step is identified at which the second smallest eigenvalue falls below a predefined threshold value 8a close to zero for the first time. This simulation step is re-turned as a simulation result 9 in simulation time, in particular in hours, minutes or seconds, and possibly as a time in the future, in particular as a calendar date. The simulation time is calculated from the distance between the measured values, i.e. the number of sampling time points N of the input matrix 3, which is generated from the vibration data 1a or the features 1b that can be calculated from it. For example, the undercut of the predefined threshold value 8a after 750 simulation steps n can be converted into a time unit of approximately half a day by dividing 750 by 1440 minutes (24 h×60 min) when using minute averages. Subsequently, further simulations are carried out according to method step h) by repeating method steps b), generating the input matrix 3, c), carrying out a simulation step 4 and generating the Laplace matrix 6a, d) calculating the eigenvalues 6b, f) selecting and storing the second smallest eigenvalue 6c, and g) identifying the number of simulation steps until the value falls below the threshold value close to zero and returning this value in simulation time. Finally, in process step i), a curve is adapted to the simulation results 9, 9′, 9″ obtained from the simulations performed, using a suitable method, and the time 7 at which the curve intersects a predefined lower boundary 8c is calculated. In FIG. 4a, all started simulations (x-axis) are plotted against the number of simulation steps until the curve falls below the predefined threshold value 8a (y-axis). FIG. 4b shows an example of the adjustment of the simulation results 9, 9′, 9″ obtained by local linear regression using Loess smoothing over the entirety of the simulation results 9, 9′, 9″ shown in FIG. 4a. The failure time or the remaining service life is calculated from the intersection of the regression curve with the predefined lower boundary 8c, which in this example is the x-axis.

FIG. 5 shows the progression of the criticality index CI over time. The curve can be used to determine the point in time at which an irreversible deterioration process starts in the sealing arrangement and the calculation of the remaining service life is triggered. This point in time can be determined using the statistical distribution of the simulation results, especially if a certain proportion of the simulation results is below a limit value, which has the value 1 in FIG. 5 and is marked by the white line after approx. 92 days (damage onset).

FIG. 6 shows the progression of the precision of the prediction error over a period of six weeks before the actual end of the service life of the sealing arrangement, i.e. the occurrence of a malfunction or total failure of the sealing arrangement, in calendar days. As can be seen from FIG. 6, the difference between the predicted end of service life and the actual occurrence of the damage event is only very small, especially in the last day before the actual failure of the sealing arrangement, which is an indicator of a very high accuracy of the predicted end of service life.

1-16. (canceled)

17. A computer-implemented method for determining the degree of wear and predicting the remaining service life of a sealing arrangement of a reciprocating compressor, the method comprising the following steps:
a) providing vibration data, or features which can be calculated therefrom, of a reciprocating part of the reciprocating compressor and which can be traced back to segments M of the movement of the reciprocating part of the reciprocating compressor;
b) generating an input matrix from the vibration data or the features which can be calculated therefrom, wherein the input matrix has a dimension (M×N) determined by the number of segments M and the number of sampling times N;
c) performing a simulation comprising a plurality of simulation steps by applying a model, with which the error propagation in a closed system can be described, on the input matrix, wherein each simulation step generates an output matrix, and wherein the output matrix of the n^{th} simulation step is used as the input matrix of the n+1^{th} simulation step;
d) selecting exactly one parameter from the values of the output matrices;
e) determining the number of simulation steps that must be performed until the selected parameter falls below a predefined threshold value close to zero as the result of the simulation performed, and outputting this number in a time unit;
f) repeating the method steps at regular discrete time intervals to obtain a plurality of simulation results; and
g) fitting a curve to the simulation results obtained, and calculating the time at which the curve intersects a predefined lower boundary;
wherein the selected parameter represents a measure for the synchronization of the vibration data traceable to the segments M or features calculable therefrom, and
the calculated intersection point is regarded as an indicator for the occurrence of a malfunction, and the predicted end of the service life of the sealing arrangement.

18. The method according to claim 17, wherein a step of forming the Laplacian matrix for each output matrix and calculating the eigenvalues of the respective Laplacian matrix is performed.

19. The method according to claim 18, wherein the parameter is selected from the calculated eigenvalues of the optionally formed Laplace matrices.

20. The method according to claim 17, wherein a step of calculating the normalized distance of the output matrix of the n+1^{th} simulation step to the output matrix of the n^{th} simulation step is performed.

21. The method according to claim 20, wherein the parameter is selected from the calculated normalized distances.

22. The method according to claim 19, wherein the second smallest eigenvalue of the Laplace matrix is selected as the parameter, and wherein the predefined threshold value is approximately zero.

23. The method according to claim 17, wherein the vibration data provided are obtained by the following sub-steps:
detecting at least one time signal x(t) of the vibration of a reciprocating part of the reciprocating compressor by at least one vibration sensor;
dividing the detected time signal x(t) of the vibration into a plurality of time segments and forming the average values of the detected time signal x(t) in the respective time segments to obtain averaged vibration values;
detecting the position of the reciprocating part of the reciprocating compressor by at least one position sensor and providing the detected position data;
dividing the movement of the reciprocating part into a plurality of segments M, based on the detected position data; and
assigning the averaged vibration values to the segments M of the movement in such a way that the respective averaged vibration values always correspond to the same segments M of the movement of the reciprocating part.

24. The method according to claim 23, wherein the features which can be calculated from the vibration data are obtained by calculating the features from the recorded time signal x(t), and said features are divided into a plurality of time segments, and the average values of the calculated features are divided in the respective time segments to obtain averaged features, and the averaged features are assigned to the segments M of the movement in such a way that the respective averaged features always correspond to the same segments M of the movement of the reciprocating part.

25. The method according to claim 17, wherein the prediction of the time at which the selected parameter falls below the predefined threshold value is made only after the parameter reaches a predetermined criticality value marking the onset of an irreversible deterioration process in the sealing arrangement.

26. The method according to claim 17, wherein the model applied to the input matrix is the time-dependent Ginzburg-Landau model (TDGL).

27. The method according to claim 17, further comprising a data transmission step for transmitting the vibration data or features to at least one ground station and/or for transmitting the predicted remaining service life of the sealing arrangement to a user interface of the reciprocating compressor, wherein at least the simulation steps and the prediction of the time at which the selected parameter falls below a predefined threshold value are carried out in whole or in part on the ground with the ground station.

28. The method according to claim 17, wherein the sealing arrangement is a piston rod packing sealing against a piston rod, or a cylinder valve delimiting a compression chamber.

29. The method according to claim 17, wherein the execution of the method is started automatically at a time selectable by a user or at fixed time intervals.

30. The method according to claim 17, further comprising the sub-step:
transmitting the identified time and/or the predicted end of the service life of the sealing arrangement to a user; and/or
estimating the degree of wear of the sealing arrangement from the behavior of the parameter over the number of simulation steps carried out and transmitting the degree of wear thus obtained to a user.

31. A preventive maintenance system for a reciprocating compressor, the preventive maintenance system having a calculating means comprising at least one processor, the calculating means being configured:
to receive position data of a reciprocating part of the reciprocating compressor;
to receive vibration data, or features that can be calculated therefrom, of the reciprocating part of the reciprocating compressor;
to assign the vibration data or features to segments M of the movement of the reciprocating part of the reciprocating compressor;
to generate an input matrix from the received vibration data or features;
to perform a plurality of simulations each comprising a plurality of simulation steps by applying a model, with which the error propagation in a closed system can be described, on the input matrix, wherein each simulation step generates an output matrix, and wherein the output matrix of the n^{th} simulation step is used as the input matrix of the n+1^{th} simulation step;
to select a parameter from the values of the output matrices, wherein the selected parameter represents a measure for the synchronization of the vibration data traceable to the segments M or features calculable therefrom;
to determine, as a result of the simulation carried out in each case, the number of simulation steps that must be carried out until the selected parameter falls below a predefined threshold value close to zero, and output this number in a time unit;
to fit a curve to the obtained simulation results, and calculate the time at which the curve intersects a predefined lower boundary, the calculated intersection point being regarded as an indicator for the occurrence of a malfunction and the predicted end of the service life of the sealing arrangement; and
to output the remaining service life of the sealing arrangement of the reciprocating compressor.

32. The preventive maintenance system according to claim 31, wherein the calculating means is also configured to form the Laplacian matrix for each output matrix, and calculate the eigenvalues of the respective Laplacian matrix, and to select the parameter from the calculated eigenvalues of the optionally formed Laplace matrices.

33. The preventive maintenance system according to claim 31, wherein the calculating means is also configured to calculate the normalized distance of the output matrix of the n+1^{th} simulation step to the output matrix of the n^{th} simulation step, and to select the parameter from the calculated normalized distances.

34. The preventive maintenance system according to claim 31, further comprising at least one position sensor which is designed to detect the position of the reciprocating part of the reciprocating compressor and is communicatively coupled to the calculation device, and at least one vibration sensor, which is designed to detect a time signal x(t) of the vibration of a reciprocating part of the reciprocating compressor and is communicatively coupled to the calculation device, the calculation device being configured to divide the detected time signal x(t) of the vibration into a plurality of time segments and form the averaged vibration values of the respective time segments, to divide the movement of the reciprocating part into a plurality of segments M, on the basis of the determined position, and to assign the averaged vibration values to these segments M of the movement in such a way that the respective averaged vibration values always correspond to the same segments M of the movement of the reciprocating part.

35. The preventive maintenance system according to claim 34, wherein at least one of the vibration sensors is arranged on a cylinder head or crosshead of the reciprocating compressor associated with the reciprocating part.

36. A reciprocating compressor comprising a preventive maintenance system according to claim 31.

37. The reciprocating compressor according to claim 36, designed as a reciprocating compressor with vertical piston movement.

38. A computer-readable storage medium embodying a computer program, the computer program comprising computer-readable program code which, when executed by at least one processor of a computer, is configured to cause the processor to perform the method according to claim 17.
